(19) United States
(12) Patent Application Publication
(10) Pub. No.: US 2010/0022104 A1
(43) Pub. Date: Jan. 28, 2010

(54) ELECTRICAL CONNECTING APPARATUS

(75) Inventors: Eichi Osato, Fuchu-shi (JP); Fukuhito Shinma, Mitaka-shi (JP); Tomoharu Arai, Wako-shi (JP)

Correspondence Address: INGRASSIA FISHER & LORENZ, P.C., 7010 E. COCHISE ROAD, SCOTTSDALE, AZ, 85253, US

(73) Assignee: KABUSHIKI KAISHA NIHON MICRONICS

(21) Appl. No.: 12/439,675

(22) PCT Filed: Sep. 18, 2007
(86) PCT No.: PCT/JP2007/068598

§ 371 Date: Mar. 2, 2009

(30) Foreign Application Priority Data
Oct. 5, 2006 (JP) 2006-274118

(51) Int. Cl. H01R 12/00

(52) U.S. Cl. 439/65

(57) ABSTRACT

An electrical connecting apparatus comprises a housing having a first recess extending in a first direction in a plane parallel to a board having a conductive portion to be connected to an electrode of a device under test and opened downward and a plurality of slits spaced in the first direction and extending in a second direction intersecting the first direction in the plane, wherein each slit communicates at one end portion in its longitudinal direction with the first recess and is opened at least upward, a plurality of plate-shaped contacts each electrically connecting the conductive portion to the electrode, having on the tip end side of the contact a tip end thrust to the electrode and a curved external surface, and arranged in the housing in a state of extending inside the slit from within the first recess with the external surface being on the lower side, and a probe holder arranged in the first recess and abutting on a part opposite the external surface of the contact so as to contact the external surface of the contact with the conductive portion. Accordingly, scraps scraped away by the tip end of the contact are prevented from reaching the board via the slit.

### TECHNICAL FIELD

The present invention relates to an electrical connecting apparatus for use in an electrical test of a flat-plate-shaped device under test such as an integrated circuit and, more specifically, relates to an apparatus electrically connecting a conductive portion formed on a board to an electrode of the device under test.

### BACKGROUND ART

A semiconductor device such as an integrated circuit has a plurality of electrodes projecting from a device main body. The semiconductor device of this kind undergoes an electrical test (inspection) with use of an electrical connecting apparatus referred to as a socket. As examples of the electrical connecting apparatuses of this kind, there are ones described in Patent Literature 1 and 2.

Patent Literature 1: Japanese Patent Appln. Public Disclosure No. 11-31566

Patent Literature 2: Japanese Patent Appln. Public Disclosure No. 2003-297506

An electrical connecting apparatus described in Patent Literature 1 or 2 includes a plate-shaped housing having in parallel a plurality of slits opened in the vertical direction, a plurality of contacts arranged in the slits, and a bar-like probe holder arranged in the housing so as to extend in the arrangement direction of the contacts. Each contact has a curved external surface.

The housing is attached to a board such as a wiring board by a plurality of screw members. The contacts have the curved external surfaces thrust to conductive portions such as a wiring pattern of the board by the probe holder in a state where the housing is attached to the board.

As the tip end (probe tip) of each contact is thrust to an electrode of a device under test, each contact scrapes away part of the electrode and electrically connects the electrode of the device under test to the conductive portion of the board. In this state, an electrical test of the device under test is performed.

However, in any of the above electrical connecting apparatuses, since each contact is arranged in the housing in a state where its tip end is located to the upper side of the slit, scraps scraped away by the tip end of the contact may reach the board via the slit and electrically short the adjacent conductive portions of the board.

### SUMMARY OF INVENTION

Technical Problem

It is an object of the present invention to prevent scraps scraped away by a tip end of a contact from reaching a board via a slit.

### Solution to Problem

An electrical connecting apparatus according to the present invention comprises a housing having a first recess extending in a first direction in a plane parallel to a board having a conductive portion to be connected to an electrode of a device under test and opened downward, and a plurality of slits spaced in the first direction and extending in a second direction intersecting the first direction in the plane, wherein each slit communicates at one end portion in its longitudinal direction with the first recess and is opened at least upward, a plurality of plate-shaped contacts each electrically connecting the conductive portion to the electrode, having on the tip end side of the contact a tip end thrust to the electrode relatively and a curved external surface, and arranged in the housing in a state of extending inside the slit from within the first recess with the external surface being on the lower side, and a probe holder arranged in the first recess and abutting on a part opposite the external surface of the contact so as to bring the external surface of the contact into contact with the conductive portion.

The tip end of each contact is distanced from the slit in the longitudinal direction of the slit as seen in a planar state.

The housing may further have a second recess opened upward and communicating with the other end portion of the slit.

Each slit may communicate at a side of its other end portion with the second recess.

Each contact may extend inside the slit obliquely upward, extend horizontally inside the slit toward the other end portion in the longitudinal direction of the slit, and further extend inside the second recess obliquely upward.

The electrical connecting apparatus may further comprise a rubber member extending in the first direction so as to close the other end portion of the slit at its upper side, arranged in the second recess, and elastically deformed by the contact when at least the tip end of the contact is thrust to the electrode of the device under test.

The housing may further have a third recess extending inside the second recess in the first direction, communicating with the slit, and opened upward, and the rubber member may be arranged in the third recess.

The electrical connecting apparatus may further comprise a guide plate arranged in the second recess and having a fourth recess that guides the device under test so that the electrodes of the device under test may abut on the tip ends of the contacts.

A surface forming the first recess may have at the back end portion a drop preventing portion preventing the contacts from dropping from the first recess in cooperation with back end portions of the contacts.

Each contact may have at the back end portion a projection projecting backward so as to be able to engage with the drop preventing portion.

Each contact may have the tip end project to the upper side of the housing.

### ADVANTAGEOUS EFFECTS OF INVENTION

With the present invention, since each contact has its tip end extend to a position distanced from the slit in the longitudinal direction of the slit as seen in a planar state, scraps scraped away by the tip end of the contact drop at locations other than the slit. Accordingly, scraps scraped away by the tip end of the contact are prevented from reaching the board via the slit.

### BRIEF DESCRIPTION OF THE DRAWINGS

FIG. 1 is a plan view showing a first embodiment of an electrical connecting apparatus according to the present invention.

FIG. 2 is a cross-sectional view obtained along the line 2-2 in FIG. 1.

FIG. 3 is a plan view of the electrical connecting apparatus shown in FIG. 1 in which a guide plate has been removed.

FIG. 4 is an enlarged plan view of the vicinity of contacts of the electrical connecting apparatus shown in FIG. 1.

FIG. 5 is an enlarged bottom view of the vicinity of the contacts of the electrical connecting apparatus shown in FIG. 1.

FIG. 6 is an enlarged cross-sectional view of the vicinity of the contact of the electrical connecting apparatus shown in FIG. 1 and shows a state where an electrode of a device under test is not thrust by the tip end of the contact.

FIG. 7 is an enlarged cross-sectional view of the vicinity of the contact of the electrical connecting apparatus shown in FIG. 1 and shows a state where the electrode of the device under test is thrust by the tip end of the contact.

FIG. 8 is an enlarged cross-sectional view of the vicinity of the contact, showing a second embodiment of a rubber member used in the electrical connecting apparatus according to the present invention.

FIG. 9 is an enlarged cross-sectional view of the vicinity of the contact, showing a third embodiment of the rubber member used in the electrical connecting apparatus according to the present invention.

FIG. 10 is an enlarged cross-sectional view of the vicinity of the rubber member, showing a fourth embodiment of the rubber member used in the electrical connecting apparatus according to the present invention.

### DESCRIPTION OF THE REFERENCE SIGNS

10 electrical connecting apparatus
12 device under test
14 main body
16 electrode
20 board
22 plate member
24 conductive portion
26 housing
28 contact
30 probe holder
32 rubber member
34 guide plate
36 first recess
38 slit
40 second recess
42 third recess
44 drop preventing portion
46 partition wall
48 plate-shaped portion
50 tip end of the contact
52 external surface of the contact
54, 64 recesses of the contact
56 projection of the contact
58 recess of the guide plate

### DESCRIPTION OF INVENTION

### Best Mode for Carrying Out the Invention

About Terms

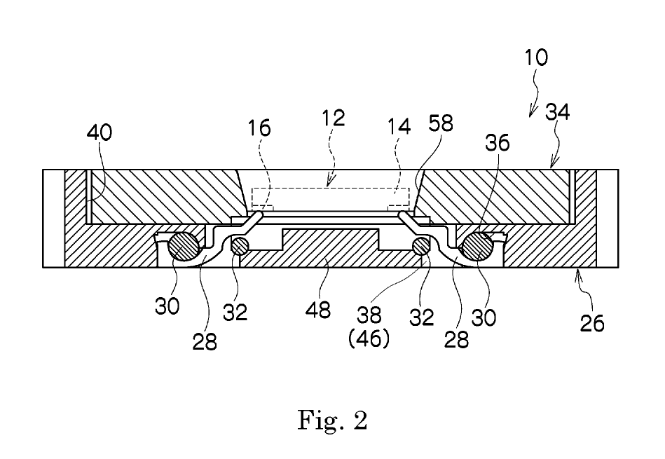

In the present invention, in FIG. 2, the right-left direction is referred to as an X direction, the direction in the backside of the drawing sheet direction is referred to as a Y direction, and the up-down direction is referred to as an up-down direction or a Z direction. However, these directions differ with the posture in which a device under test is arranged in a testing apparatus.

Accordingly, as for the above directions, the X direction and the Y direction may be determined to be within any one plane of a horizontal plane, an inclined surface inclined to the horizontal plane, and a vertical plane vertical to the horizontal plane or may be determined to be a combination of these planes in accordance with an actual testing apparatus.

Also, in the present invention, the probe tip side of a contact is referred to as a tip end, and the side opposite to it is referred to as a back end.

### DESCRIPTION OF EMBODIMENTS

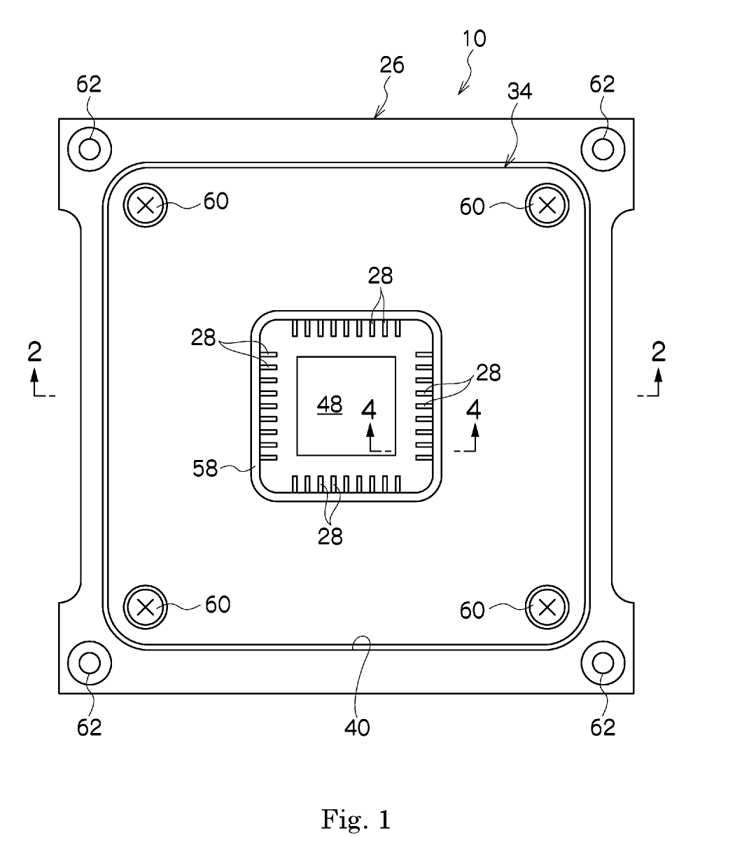

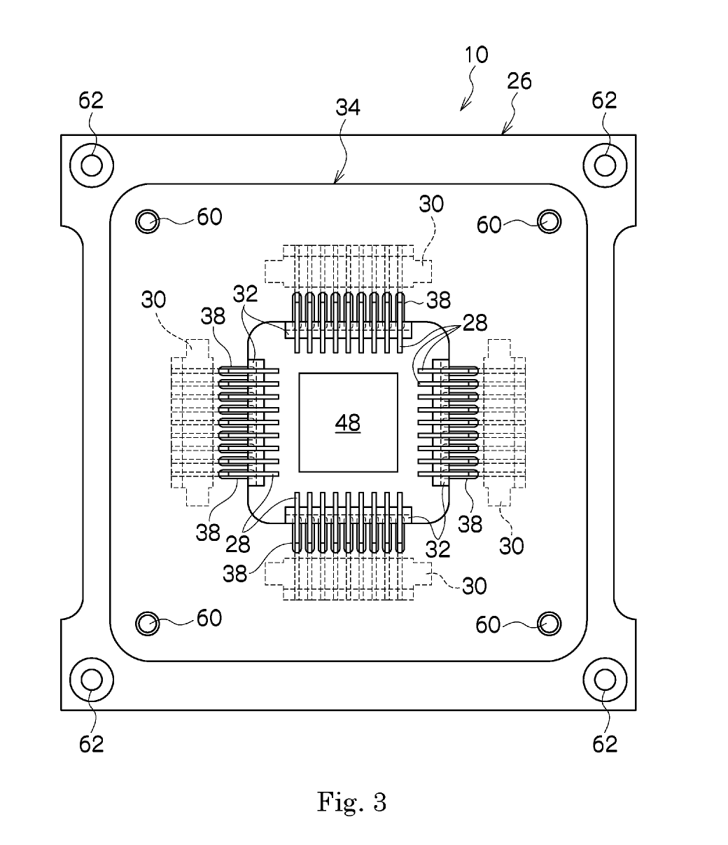

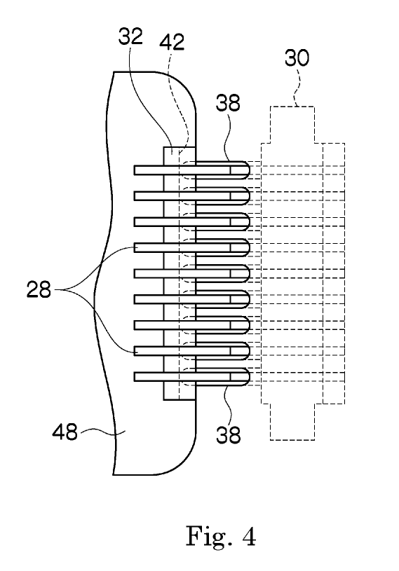

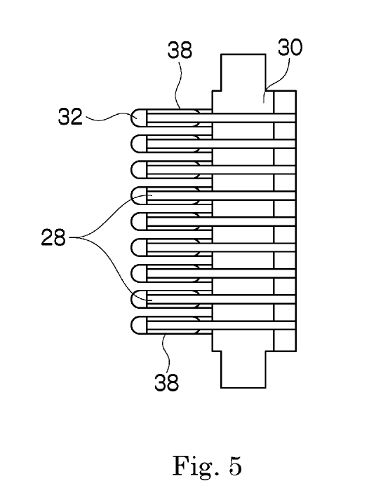

Referring to FIGS. 1 to 7, an electrical connecting apparatus 10 is used as an auxiliary apparatus in an electrical test (that is, an inspection) of a flat-plate-shaped device under test 12. The device under test 12 is a semiconductor device such as a packaged or molded integrated circuit, an unpackaged or unmolded integrated circuit, etc. in the example shown in the figures.

The device under test 12 has a main body 14 formed in a rectangular plate-like shape and a plurality of electrodes 16 provided at each side of the rectangle on one surface of the main body 14. The electrodes 16 are formed in short strip shapes, are divided into four electrode groups each corresponding to one side of the rectangle of the main body 14, and are arranged in parallel per electrode group.

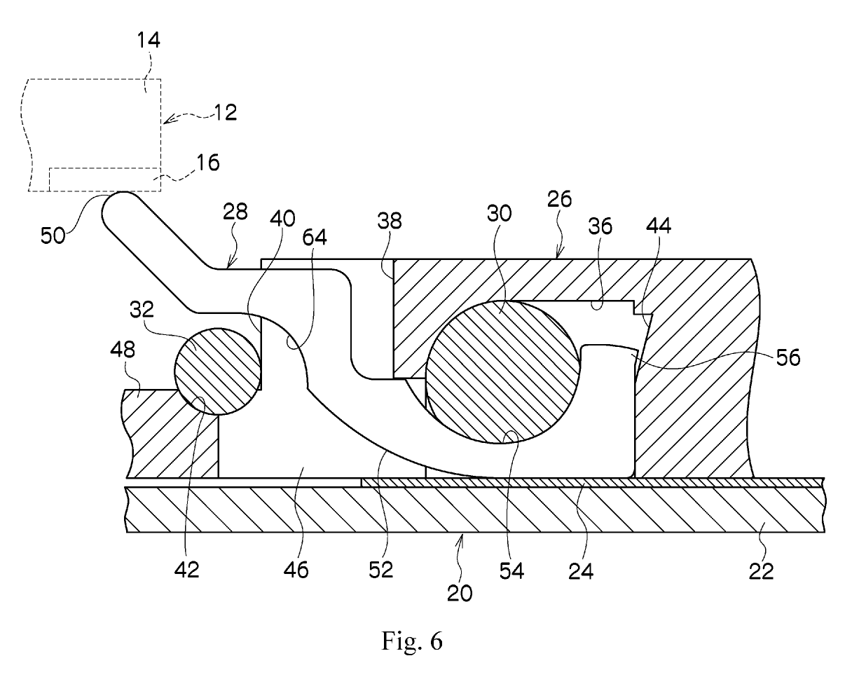

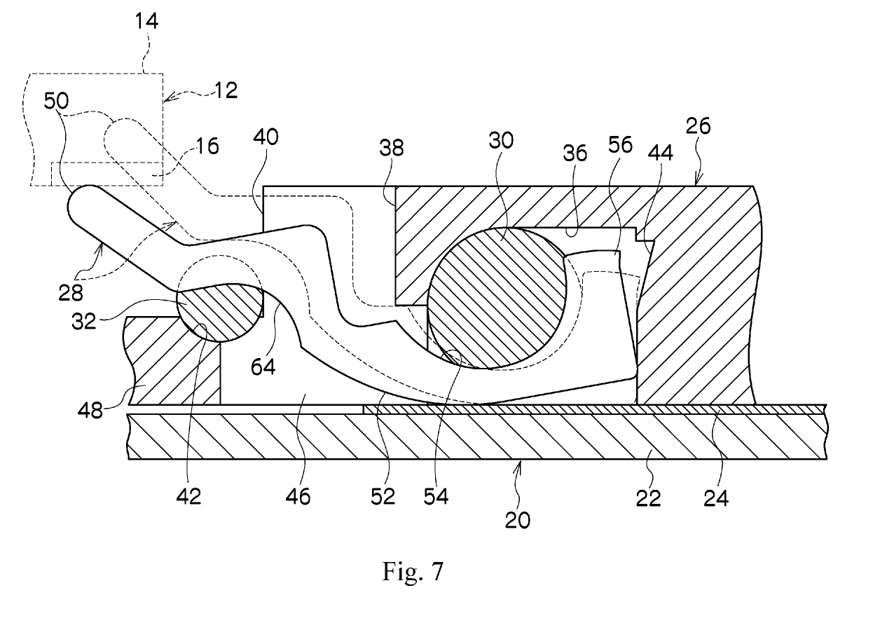

A board 20 to attach the electrical connecting apparatus 10 thereto is a wiring board in which a conductive wiring pattern is formed by a printed wiring technique on one surface of a plate member 22 made of an electrical insulating material such as glass-containing epoxy resin and has on one surface of the plate member 22 a plurality of strip-shaped wiring portions or conductive portions 24 each corresponding to one electrode 16 of the device under test 12, as shown in FIGS. 6 and 7.

Each conductive portion 24 is part of the wiring pattern. The conductive portions 24 are divided into four conductive portion groups each corresponding to one side of the rectangle of the main body 14 of the device under test 12 and are formed in parallel per conductive portion group in a state of extending in a direction intersecting the corresponding side and being distanced in the longitudinal direction of the side in the vicinity of the corresponding side.

The board 20 is generally manufactured by a user performing an electrical test of the device under test 12 in accordance with a type of the device under test 12. However, the board 20 may be manufactured on the part of a manufacturer of the connecting apparatus 10.

As shown in FIGS. 1 to 7, the connecting apparatus 10 includes a rectangular plate-shaped housing 26 attached to the board 20, a plurality of plate-shaped contacts 28 arranged in parallel in the housing 26 and each corresponding to one pair consisting of the electrode 16 and the conductive portion 24, a plurality of long probe holders 30 arranged in the housing 26 so as to contact the contacts 28, a plurality of long rubber members 32 arranged in the housing 26, and a guide plate 34 arranged in the housing 26.

The housing 26 has four first recesses 36 extending in a first direction (X direction) or a second direction (Y direction) intersecting the first direction in the horizontal plane parallel to the board 20 and opened downward, a plurality of slits 38 spaced in the first or second direction (X direction or Y direction) and extending in the second or first direction (Y direction or X direction) in the aforementioned horizontal plane, a second recess 40 provided at the center area of the housing 26 and opened upward, and four third recesses 42 extending in the first or second direction inside the second recess 40 and opened upward.

Each first recess 36 corresponds to one side of the rectangle of the main body 14 and extends in the longitudinal direction of the corresponding side (first or second direction). The back end side inward surface out of the surfaces forming each first recess 36 has at the back portion a drop preventing portion 44 set back so as to prevent the contacts 28 from dropping from the first recess in cooperation with the back end portions of the contacts 28.

The upper corner portion on the tip end side of each first recess 36 is adapted to be an arc surface. The width dimensions of both end portions of each first recess 36 are adapted to be shorter than that of the intermediate area, and the intermediate area is adapted to be an area longer than the length of the arrangement area of the slits 38 of the corresponding slit group.

Each end portion of the first recess 36 has a shorter width dimension or a smaller curvature radius than a half of the width dimension of the intermediate area of the first recess 36 and a center or a curvature center corresponding to the curvature center of the arc surface of the tip end side upper corner portion so that the end portion of the probe holder 30 may be fitted in it in a state of interference fit.

The center area of the housing 36 is adapted to be a plate-shaped portion 48 formed in a rectangular shape as seen in a planar state.

The slits 38 are divided into four slit groups each corresponding to one pair consisting of a side of the rectangle and the first recess 36 and are spaced in the longitudinal direction of the corresponding side and first recess 36 and extend in a direction intersecting the corresponding side. A gap between the adjacent slits 38 of each slit group is adapted to be a partition wall 46.

Each slit 38 is opened to the upper and lower sides of the housing 26 and communicates at the lower portion on one end side (back end side) in the longitudinal direction with the lower portion on the tip end side of the corresponding first recess 36 and communicates at the upper portion on the other end side (tip end side) in the longitudinal direction with the second recess 40.

The second recess 40 has a smaller first recess area around the plate-shaped portion 48 of the housing 26 and a second recess area continuing into the upper portion of the first recess area and larger than the first recess area, as seen in a planar state.

The first and second recess areas are formed in rectangular shapes analogous to the main body 14 of the device under test 12 and are formed coaxially with and analogously to it, as seen in a planar state. The slits 38 are opened at their tip end sides to one side of the rectangle of the first recess area per slit group.

The area around the plate-shaped portion 48 of the housing 26 is adapted to be lower than the second recess area by the first recess area of the second recess 40.

Each third recess 42 corresponds to one side of the rectangle and extends in the longitudinal direction (X or Y direction) of the corresponding side. Each third recess 42 has a width dimension reaching the tip end upper portion of the partition wall 46 from the upper corner portion on the outside of the plate-shaped portion 48 of the housing 26 and has an arc-like back bottom surface.

The width dimension of each third recess 42 is approximately uniform over its length range. However, as described later, the width dimensions of both end portions of each third recess 42 may be shorter than that of another area. In such a case, the intermediate area between both the end portions is adapted to be an area longer than the length of the arrangement area of the slits of the corresponding slit group.

The above housing 26 may be made of an electrical insulating material such as synthetic resin.

Each contact 28 has an arc-like tip end (or a probe tip) 50 to be thrust to the electrode 16 on the tip end side, a curved external surface 52, and an arc-like recess 54 opened upward on the back end side.

Each contact 28 is arranged in the housing 26 in a state of extending inside the slit 38 and inside the first recess area of the second recess 40 from within the first recess 36 in a state where its external surface 52 is on the lower side and in a state where the tip end 50 projects to the upper side of the housing 26 and extends to a position distanced from the slit 38 in the longitudinal direction of the slit 38 as seen in a planar state.

The back end portion of each contact 28 is located within the first recess 36 and has at the upper portion of the back end surface a projection 56 projecting backward from the upper portion of the back end surface so as to be locked by the drop preventing portion 44 of the first recess 36. The corner portion on the lower side of the back end surface of each contact 28 is adapted to be an arc surface having a small curvature radius.

The area on the front side of the back end portion (back end front-side area) and the area further on the tip end side from the back end front-side area (tip end area) out of each contact 28 act as an arm portion that elastically deforms when the electrode 16 of the device under test 12 is thrust by the tip end 50.

The arm portion extends inside the slit 38 from the back end portion obliquely upward, extends horizontally inside the slit 38 toward the other end portion in the longitudinal direction of the slit 38, and further extends inside the second recess 40 obliquely upward in the example shown in the figures.

The back end surface of each contact 28 contacts an inclined surface set back from the upper end of the back end side inward surface out of the surfaces forming the first recess 36 except the projection 56 and the corner portion on the lower side of the back end surface.

The probe holder 30 is formed in a bar shape having a circular cross-section made of an elastic member that can be elastically deformed such as silicon rubber and corresponds to each pair consisting of a side of the rectangle and the first recess 36. Thus, each probe holder 36 extends inside the corresponding first recess 36 in the longitudinal direction of the corresponding first recess 36.

Both the end portions of each probe holder 30 are fit in both the end portions of the corresponding first recess 36 in a state of interference fit. This prevents each probe holder 30 from dropping from the housing 26.

The intermediate area between both the end portions of each probe holder 30 contacts the arc surface at the upper corner portion on the tip end side of the first recess 36 and abuts on the recesses 54 of the contacts 28 of the corresponding contact group.

The rubber member 32 is also formed in a bar shape having a circular cross-section made of an elastic member that can be elastically deformed such as silicon rubber and corresponds to each pair consisting of a side of the rectangle and the third recess 42. Thus, each rubber member 32 is received at its part within the third recess 42 and extends in the longitudinal direction of the third recess 42.

In the example shown in the figures, each rubber member 32 has an approximately uniform diameter dimension over the entire length range and is located on the lower side of the arm portions of the contacts 28 of the corresponding contact group.

However, as described above, the width dimensions of both end portions of the third recess 42 may be shorter than that of another area, or the diameter dimensions of both end portions of the rubber member 32 may be longer than that of the intermediate area to have both the end portions of the rubber member 32 fitted in both the end portions of the corresponding third recess 42 in a state of interference fit. In such a case, the intermediate area of each rubber member 32 is adapted to have a longer dimension than the length range of the corresponding slit group.

The guide plate 34 is formed in a rectangular shape analogous to the second recess 40 and is arranged in the second recess 40. The guide plate 34 has a rectangular recess 58 to receive the device under test 12 so that the electrodes 16 of the device under test may abut on the tip ends 50 of the contacts 28.

The recess 58 is formed in a rectangular planar shape slightly larger than the device under test 12 and analogous to the main body 14 of the device under test 12. The inward surface of the recess 58 is adapted to an inclined surface directing from the outside to the center side of the guide plate 34 to become smaller towards the lower side so as to guide the device under test 12.

The connecting apparatus 10 can be assembled in the following manner.

First, each probe holder 30 is arranged in the first recess 36, and the rubber members are arranged in the third recesses 42.

Next, the contacts 28 of each contact group are arranged with each arm portion made to go through the corresponding slit 38 from the corresponding first recess 36, and the tip ends 50 are arranged in a state of projecting toward the first recess area of the second recess 40. Accordingly, the contact 28 is held by the housing 26 and the probe holder 30 at its back end portion and is prevented from dropping from the housing 26 by the drop preventing portion 44 and the projection 56.

Next, the guide plate 34 is arranged in the second recess area of the second recess 40. The guide plate 34 is removably fixed to the housing 26 by a plurality of screw members 60 penetrating this in the thickness direction and screwed in the housing 26.

As a result of the above, the connecting apparatus 10 is assembled to enable disassembly. When the assembled connecting apparatus 10 is to be disassembled, a reverse operation of the above is done.

In the state where the connecting apparatus 10 is assembled, the arm portion of each contact 28 is distanced upward from the rubber member 32 as shown in FIG. 6.

Also, each contact 28 has its tip end 50 project further upward than the upper end surface of the housing 26. However, since the device under test 12 is received in the recess 58, each contact 28 may be shaped so that the tip end 50 may be located within the recess 58.

The assembled connecting apparatus 10 is detachably attached to the board 20 by a plurality of screw members 62 penetrating the housing 26 and screwed in the board 20.

In the state where the connecting apparatus 10 is attached to the board 20 as above, the contacts 28 contact at parts of the external surfaces 52 the conductive portions 24 of the board 20 by the probe holders 30 and are kept in such a state. Thus, the contacts 28 are prevented from dropping from the housing 26 reliably, and the contacts 28 and the conductive portions 24 are electrically connected reliably.

When both the end portions of each probe holder 30 are fitted in both the end portions of each first recess 36 in a state of interference fit, and the center area of each probe holder 30 abuts on the recesses 54 of the contacts 28 as above, the positions of the contacts 28 against the housing 26 are stabled, and the contacts 28 are prevented from dropping from the housing 26 more reliably.

At the time of the test, the device under test 12 is inserted in the recess 58 of the guide plate 34 from the upper side. At this time, when the device under test 12 is displaced against the connecting apparatus 10, the device under test 12 abuts on the inclined surfaces of the recess 58 and is guided to the center of the recess 58 by the inclined surfaces. Accordingly, the device under test 12 is housed in the connecting apparatus 10 in a state where the electrodes 16 abut on the tip ends of the contacts 28.

When the device under test 12 arranged in the connecting apparatus 10 is pressed down by a not shown pressure body, each contact 28 falls under an overdriving effect, is elastically deformed from the state shown with a dashed line to the state shown with a solid line in FIG. 7, and is thrust to the rubber member 32. At this time, a force that moves backward the contact 28 along its external surface 52 acts on the contact 28.

However, since the back end of each contact 28 directly contacts the back end side inward surface of the first recess 36, each contact 28 is displaced to bring a state shown with a solid line in FIG. 7 with the back end lower portion being as a supporting point to elastically deform the probe holder 30.

Accordingly, since the tip end 50 is displaced against the electrode 16 in the longitudinal direction of the contact 28, and the contact part of the contact 28 with the conductive portion 24 shifts to one on the tip end 50 side, the tip end 50 of each contact 28 causes a friction effect (or a scratch effect) that scrapes away part of the oxide film existing on the surface of the electrode 16.

Since the device under test's 12 being pressed down by the aforementioned pressure body causes each contact 28 to be thrust to the conductive portion 24 as above, a space may exist between the contact 28 and the conductive portion 24 so that each contact 28 may not be thrust to the conductive portion 24 by the probe holder 30 in a state where the electrical connecting apparatus is assembled or in a state where the device under test 12 is not pressed down by the pressure body.

Although each contact 28 and the rubber member 32 are distanced in a state where the connecting apparatus 10 is assembled in the example shown in the figures, the arm portion of the contact 28 and the rubber member 32 may contact each other, and the rubber member 32 may be elastically deformed by the arm portion of the contact 28.

With the connecting apparatus 10, the following effects are achieved.

Since each contact 28 has its tip end 50 extend to a position distanced from the slit 38 in the longitudinal direction of the slit 38 as seen in a planar state, scraps scraped away by the tip end 50 of the contact 28 drop at locations other than the slit 38. Accordingly, scraps scraped away by the tip end of the contact 28 are prevented from reaching the board 22 via the slit 38.

Scraps scraped away by the tip end of the contact 28 are prevented from reaching the board via the slit 38 more reliably as the rubber member 32 closes the upper portion on the tip end side of the slit 36.

Although the contacts 28 are maintained in a stable manner, the connecting apparatus 10 is manufactured easily. The device under test 12 is arranged in the connecting apparatus 10 by itself correctly. The electrodes 16 of the device under test 12 contact the tip ends 50 of the contacts 28 reliably. As the contact 28 elastically deforms the probe holder 30 and the rubber member 32, a predetermined probe pressure can be applied between the conductive portion 24 and the contact 28, and a friction effect acts on the electrode 16 effectively. Electrical short among the contacts 28 is prevented reliably although the structures of the probe holder 30 and the rubber member 32 are simple.

In the example shown in the figures, the contact 28 has a recess 64 at a contact part to the rubber member 32 when the tip end 50 is thrust to the electrode 16. However, such a recess 64 may not be provided to the contact 28.

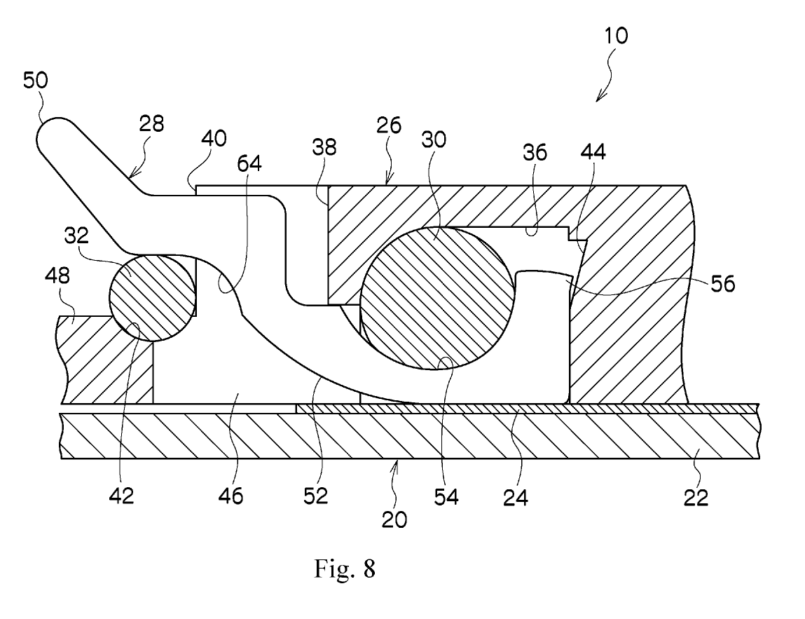

Instead of each contact's 28 being distanced from the rubber member 32 in a state where the tip end 50 is thrust to the electrode 16, the contact 28 may contact the rubber member 32 as shown in FIG. 8, and the rubber member 32 may be elastically deformed by the contact 28 appropriately.

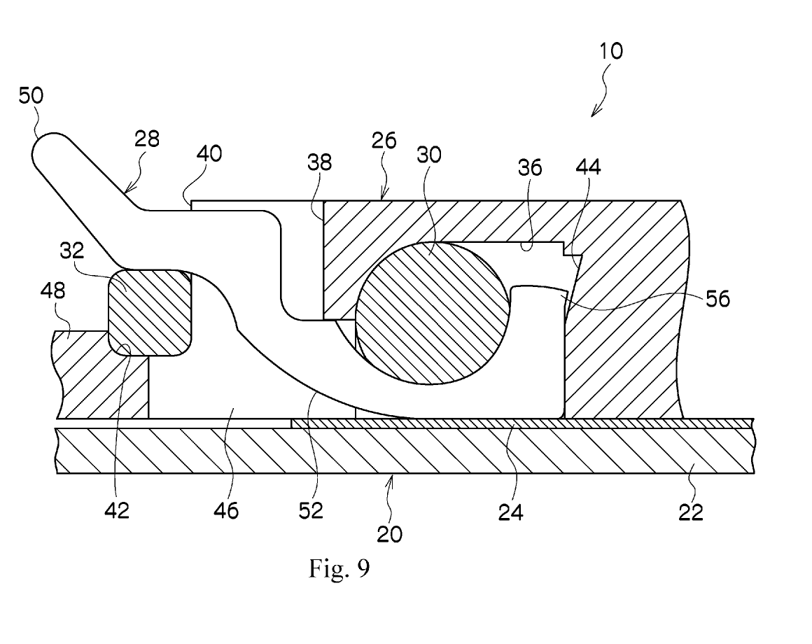

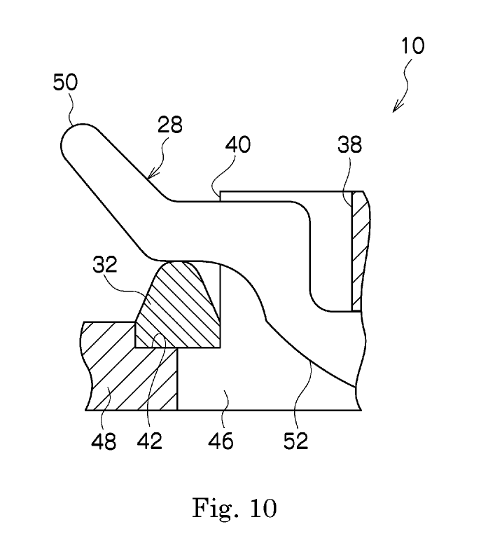

Instead of using the rubber member 32 having a circular cross-section, a rubber member having another cross-sectional shape may be used such as the rubber member 32 having a rectangular cross-sectional shape as shown in FIG. 9, the rubber member 32 having a semi-cylindrical or triangular cross-sectional shape as shown in FIG. 10, etc.

### INDUSTRIAL APPLICABILITY

The present invention is not limited to the above embodiments, but can be altered without departing from the spirit of the present invention. For example, the present invention can be applied to an electrical connecting apparatus for a test of another flat-plate-shaped device under test such as a liquid crystal display panel.

1. An electrical connecting apparatus attached to a board and electrically connecting a conductive portion formed on said board to an electrode of a device under test, comprising:
a housing having a first recess extending in a first direction in a plane parallel to said board and opened downward and a plurality of slits spaced in said first direction and extending in a second direction intersecting said first direction in said plane, wherein each slit communicates at one end portion in its longitudinal direction with said first recess and is opened at least upward;
a plurality of plate-shaped contacts each electrically connecting said conductive portion to said electrode, having a tip end thrust to said electrode relatively and a curved external surface, and arranged in said housing in a state of extending inside said slit from within said first recess with said external surface being on the lower side; and
a probe holder arranged in said first recess and abutting on a part opposite said external surface of said contact so as to contact said external surface of said contact with said conductive portion,
wherein said tip end of each contact is distanced from said slit in the longitudinal direction of said slit as seen in a planar state.

2. The electrical connecting apparatus according to claim 1, wherein said housing further has a second recess opened upward and communicating with the other end portion of said slit.

3. The electrical connecting apparatus according to claim 2, wherein each slit communicates at a side of its other end portion with said second recess.

4. The electrical connecting apparatus according to claim 3, wherein each contact extends inside said slit obliquely upward, extends horizontally inside said slit toward the other end portion in the longitudinal direction of said slit, and further extends inside said second recess obliquely upward.

5. The electrical connecting apparatus according to claim 2, further comprising a rubber member extending in said first direction so as to close the other end portion of said slit at its upper side, arranged in said second recess, and elastically deformed by said contact when at least said tip end of said contact is thrust to said electrode of said device under test.

6. The electrical connecting apparatus according to claim 5, wherein said housing further has a third recess extending inside said second recess in said first direction, communicating with said slit, and opened upward, and said rubber member is arranged in said third recess.

7. The electrical connecting apparatus according to claim 6, further comprising a guide plate arranged in said second recess and having a fourth recess that guides said device under test so that said electrodes of said device under test may abut on said tip ends of said contacts.

8. The electrical connecting apparatus according to claim 1, wherein a surface forming said first recess has at the back end portion a drop preventing portion preventing said contacts from dropping from said first recess in cooperation with back end portions of said contacts.

9. The electrical connecting apparatus according to claim 7, wherein each contact has at the back end portion a projection projecting backward so as to be able to engage with said drop preventing portion.
